(19) United States
(12) Patent Application Publication
(10) Pub. No.: US 2014/0193680 A1
(43) Pub. Date: Jul. 10, 2014

(54) BATTERY MODULE

(71) Applicant: SAMSUNG SDI CO., LTD., Yongin-si (KR)

(72) Inventors: Jin-Bok LEE, Yongin-si (KR); Jang-Wook LEE, Yongin-si (KR)

(73) Assignee: SAMSUNG SDI CO., LTD., Yongin-si (KR)

(21) Appl. No.: 14/098,573

(22) Filed: Dec. 6, 2013

Related U.S. Application Data
(60) Provisional application No. 61/750,096, filed on Jan. 8, 2013.

(51) Int. Cl. H01M 10/48; H01M 2/12

(52) U.S. Cl. CPC H01M 10/482; H01M 10/486; H01M 2/12
USPC 429/82; 429/92; 429/90

(57) ABSTRACT

A battery module may include batteries that include electrode terminals, and a measurement member that measures one or more of a voltage, a current, or a temperature of each of the batteries. The measurement member may include receiving portions, and the battery module may include connection members that electrically connecting electrode terminals of neighboring batteries. Each of the connection members may include a protrusion extending therefrom, and each protrusion may be electrically connected to the measurement member. Each protrusion may also include an uppermost surface that faces away from the batteries, and the uppermost surface of each protrusion may engage one of the receiving portions.

### RELATED APPLICATION

The present application claims priority under 35 U.S.C. §119 to U.S. Provisional Application No. 61/750,096, filed on Jan. 8, 2013, and entitled: “BATTERY MODULE,” which is incorporated herein by reference in its entirety.

### BACKGROUND

1. Field

Embodiments relate to a battery module.

2. Description of the Related Art

A rechargeable battery differs from a primary battery in that it can be repeatedly charged and discharged, while the latter makes only the irreversible conversion of chemical to electrical energy. A low-capacity rechargeable battery may be used as the power supply for small electronic devices, such as, e.g., cellular phones, notebook computers and camcorders, while the high-capacity rechargeable battery may be used as the power supply for, e.g., driving motors in hybrid vehicles and the like.

### SUMMARY

Embodiments are directed to a battery module including batteries, each of the batteries including electrode terminals, a measurement member that measures one or more of a voltage, a current, or a temperature of each of the batteries, the measurement member including receiving portions, and connection members, each of the connection members electrically connecting electrode terminals of neighboring batteries. Each of the connection members may include a protrusion extending therefrom, each protrusion being electrically connected to the measurement member and including an uppermost surface that faces away from the batteries, the uppermost surface of each protrusion engaging one of the receiving portions.

The uppermost surface of each protrusion may engage a lower surface of the receiving portion.

The receiving portions may be grooves, and the protrusion of each of the connection members may be inserted into one of the grooves.

The grooves each may have a first width, the protrusion of each of the connection members may have a second width, and the first width may be smaller than the second width.

The protrusion of each of the connection members may extend from an uppermost surface of each of the connection members, and the uppermost surface of each protrusion may be coplanar with the uppermost surface of each of the connection members.

The batter module may further include a column on the protrusion of each of the connection members. The receiving portions may be through-holes, and the column of each of the connection members may project through one of the through-holes.

The protrusion of each of the connection members may extend from an uppermost surface of each of the connection members in a direction parallel to the uppermost surface of each of the connection members, and the column of each of the connection members may project from the protrusion in a direction perpendicular to the uppermost surface of each of the connection members.

The column of each of the connection members may have a first portion with a first diameter and a second portion with a second diameter, the second portion may be between the first portion and the protrusion of each of the connection members, and the first diameter may be greater than the second diameter.

The column of each of the connection members may be coupled to the measurement member with a separate fastener.

Each of the connection members may be welded to a first electrode terminal of one battery and a second electrode terminal of a neighboring battery.

The electrode terminals of the batteries may be arranged in a first row and a second row, the first row may be substantially parallel to the second row, and the connection members may include first connection members over the electrode terminals arranged in the first row, and second connection members over the electrode terminals arranged in the second row.

The battery module may further include single-terminal connection members, each of the single-terminal connection members being electrically connected to one of the electrode terminals of only one of the batteries. Each of the single-terminal connection members may include a protrusion that extends therefrom, each protrusion of the single-terminal connection members may be electrically connected to the measurement member, and may include an uppermost surface that faces away from the batteries. The uppermost surface of each protrusion of the single-terminal connection members may engage one of the receiving portions.

The batteries may be arranged in a stack, the stack may include a first battery on a first side of the stack and a second battery on a second side of the stack, the first side may be opposite the second side, and the single-terminal connection members may include a first single-terminal connection member electrically connected to one of the electrode terminals of only the first battery, and a second single-terminal connection member electrically connected to one of the electrode terminals of only the second battery.

The measurement member may include a flexible circuit board.

Embodiments are also directed to a battery module including batteries, each of the batteries including electrode terminals and a vent hole, and a measurement member that measures one or more of a voltage, a current, or a temperature of each of the batteries. The measurement member may include at least one exposure portion and receiving portions, the at least one exposure portion may expose at least one vent hole of the batteries. The battery module may also include connection members, each of the connection members may electrically connect electrode terminals of neighboring batteries and may include a protrusion, the protrusion of each of the connection members may be electrically connected to the measurement member and may engage one of the receiving portions.

The measurement member may include a first body portion and a second body portion, the first body portion and the second body portion may extend along opposite sides of the at least one exposure portion, and the first body portion and the second body portion may extend between the electrode terminals of each of the batteries.

The at least one exposure portion may expose the vent hole of each of the batteries.

The at least one exposure portion may include a first exposure portion and a second exposure portion, the first exposure portion may expose a first vent hole of a first battery, and the second exposure portion may expose a second vent hole of a second battery.

The at least one exposure portion may be a single exposure portion that exposes all of the vent holes of the batteries.

### BRIEF DESCRIPTION OF THE DRAWINGS

Features will become apparent to those of skill in the art by describing in detail exemplary embodiments with reference to the attached drawings in which:

FIG. 1 illustrates a perspective view of a battery module according to a first exemplary embodiment.

FIG. 2 illustrates an exploded perspective view of the battery module of FIG. 1.

FIG. 3 illustrates a top plan view of a connection member and a measurement member of FIG. 1 in a separated state.

FIG. 4 illustrates a partially exploded perspective view of a connection member and a measurement member according to a second exemplary embodiment.

FIG. 5 illustrates a side view of the connection member and the measurement member of FIG. 4 in a coupled state.

FIG. 6 illustrates a partially exploded perspective view of the connection member and the measurement member according to the second exemplary embodiment.

FIG. 7 illustrates a side view of the connection member and the measurement member of FIG. 6 in a coupled state.

FIG. 8 illustrates a perspective view of a battery module according to a third exemplary embodiment.

FIG. 9 illustrates a partially exploded perspective view of the connection member and the measurement member of FIG. 8.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another element, it can be directly on the other element, or intervening elements may also be present. In addition, it will also be understood that when an element is referred to as being “between” two elements, it can be the only element between the two elements, or one or more intervening elements may also be present. Like reference numerals refer to like elements throughout.

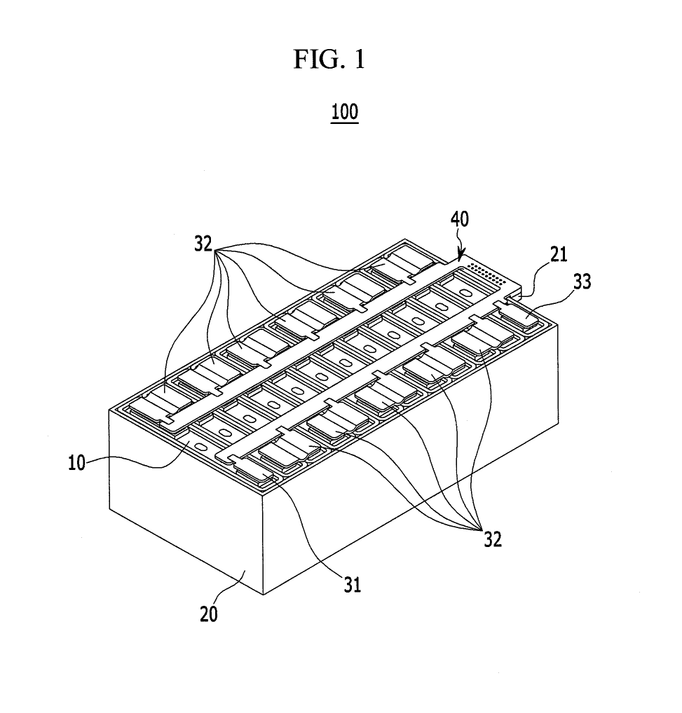

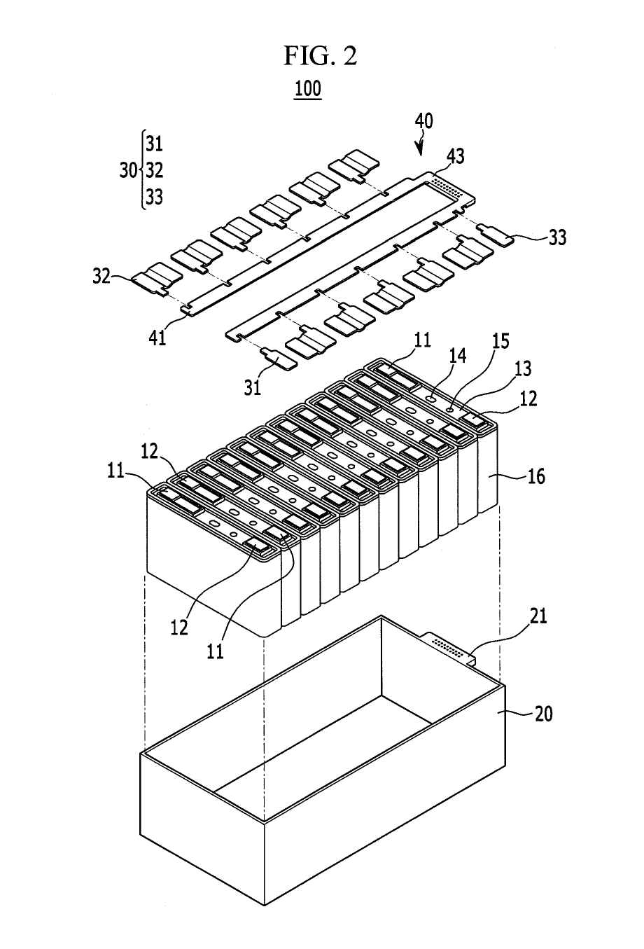

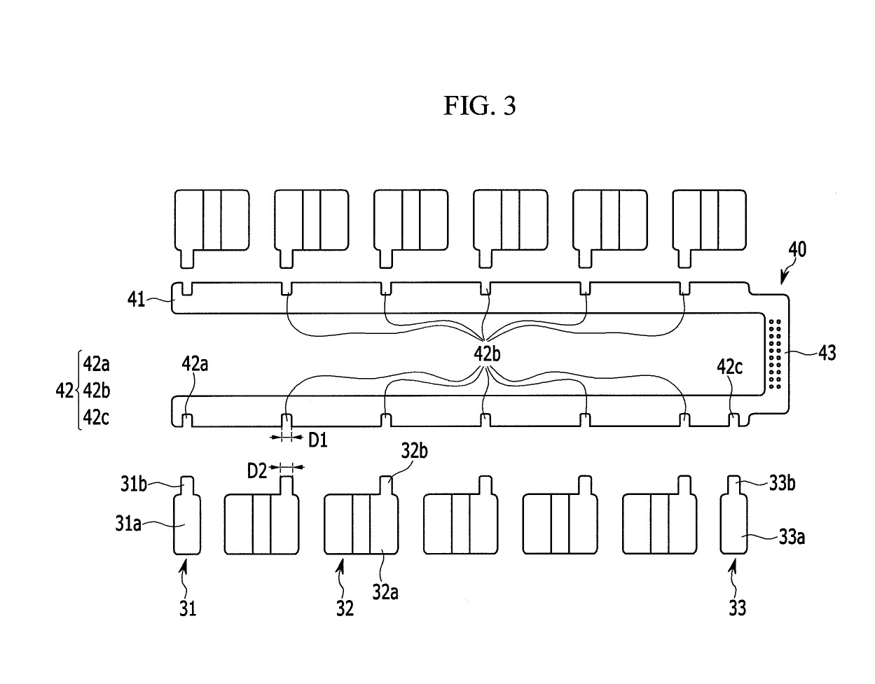

FIG. 1 illustrates a perspective view of a battery module according to a first exemplary embodiment, FIG. 2 illustrates an exploded perspective view of FIG. 1, and FIG. 3 illustrates a top plan view of a connection member and a measurement member of FIG. 1 in a separated state.

Referring to FIG. 1 and FIG. 2, a battery module 100 according to the present exemplary embodiment may include a plurality of rechargeable batteries 10, each having a first electrode terminal 11 and a second electrode terminal 12, and a receiving container 20 in which the rechargeable batteries 10 are received.

The battery module 100 according to the present exemplary embodiment is formed by coupling the rechargeable batteries 10 in series. However, the embodiments are not limited thereto, and the rechargeable batteries 10 may be coupled in parallel or coupled in a serial-and parallel combination.

A case 16 of the rechargeable battery 10 of the present exemplary embodiment may be formed in the shape of a prism and a cap plate 13 may be coupled to one opening of the case, and the first electrode terminal 11 and the second electrode terminal 12 may protrude through the cap plate 13.

Here, as shown in FIG. 1, the first electrode terminal 11 and the second electrode terminal 12 of the present exemplary embodiment may be plate-shaped terminals, respectively. However, the shape of the electrode terminals according to the embodiments is not limited to a plate, and the terminals may be bolt-type electrode terminals, or a different type of terminal.

In addition, the first electrode terminal 11 and the second electrode terminal 12 may be electrically connected to one of a positive electrode and a negative electrode of an electrode assembly (not shown) received in the case 16.

The cap plate 13 may include a vent hole 14 and a vent member may be inside the vent hole 14 to open when an internal pressure is increased. The cap plate may also include a sealing cap 15 sealing an electrolyte injection opening.

In addition, the case 16 according to the present exemplary embodiment may be electrically connected with the positive electrode or the negative electrode of the electrode assembly (not shown) through the first electrode terminal 11 or the second electrode terminal 12.

The rechargeable batteries 10 according to the present exemplary embodiment may be electrically connected with each other by a connection member 30. For example, when neighboring rechargeable batteries 10 are received in the receiving container 20, the first electrode terminals 11 or the second electrode terminals 12 of the rechargeable batteries 10 may be serially disposed such that two columns may be formed. Thus, when the rechargeable battery 10 is received in the receiving container 20 such that the first electrode terminals 11 and the second electrode terminals 12 are alternatively disposed in each of the two columns, first electrode terminals 11 and second electrode terminals 12 of neighboring rechargeable batteries 10 are disposed in parallel so that the rechargeable batteries 10 can be coupled in series. That is, the rechargeable batteries 10 received in the receiving container 20 may be electrically coupled in series by coupling the connection member 30 to each of the first electrode terminal 11 and the second electrode terminal 12 disposed in parallel.

In addition, the rechargeable batteries 10 and a measurement member 40 may be electrically coupled through the connection member 30 according to the present exemplary embodiment. That is, the connection member 30 according to the present exemplary embodiment may be coupled with the first electrode terminal 11 or the second electrode terminal 12 and the measurement member 40, and thus the rechargeable batteries 10 and the measurement member 40 may be electrically connected through the connection member 30.

Hereinafter, a coupling relationship between the connection member 30, the first and second electrode terminals 11 and 12, and the measurement member 40 according to the present exemplary embodiment will be described in further detail.

The connection member 30 according to the present exemplary embodiment may include a first connection member 31, a second connection member 32, and a third connection member 33.

The first connection member 31 according to the present exemplary embodiment may include a first body 31a coupled to the second electrode terminal 12 of the outermost battery module 100 and a first protrusion 31b extending from one side of the first body 31a.

In addition, the second connection member 32 according to the present exemplary embodiment may include a second body 32a coupled to at least one of the first and second electrode terminals 11 and 12 (e.g., by welding), and a second protrusion 32b extending from one side of the second body 32a.

Thus, a part of the second body 32a may be coupled to the first electrode terminal 11 disposed opposite to the second electrode terminal 12 of the outermost rechargeable battery 10 to which the first connection member 31 is coupled, and the other portion of the second body 32a may be coupled to the second electrode terminal 12 of the neighboring rechargeable battery 10.

Here, the second connection member 32 of the present exemplary embodiment may include a plurality of connection members. Thus, the first electrode terminals 11 and the second electrode terminals 12 formed in the rechargeable batteries 10 coupled in series may be sequentially connected by the plurality of second connection members 32, respectively.

In addition, the third connection member 33 according to the present exemplary embodiment may include a third body 33a and a third protrusion 33b. According to the present exemplary embodiment, the third body 33a of the third connection member 33 may be coupled to the first electrode terminal 11 of the outermost rechargeable battery 10 that is disposed opposite to the rechargeable battery 10 to which the first connection member 31 is coupled. Thus, the rechargeable batteries 10 received in the receiving container 20 according to the present exemplary embodiment may be electrically coupled in series by the first, second, and third connection members 31, 32, and 33.

The first, second, and third protrusions 31b, 32b, and 33b, may have an uppermost surface facing away from the batteries 10, and may extend from an uppermost surface of the respective first, second, and third connection members 31, 32, and 33. The uppermost surfaces of the first, second, and third protrusions 31b, 32b, and 33b may be coplanar with the uppermost surface of the respective first, second, and third connection members 31, 32, and 33. The uppermost surfaces of the first, second, and third protrusions 31b, 32b, and 33b may engage respective receiving portions (e.g., grooves and/or openings) in the measurement member (as discussed below). The uppermost surfaces of the first, second, and third protrusions 31b, 32b, and 33b may engage a lower surface of the receiving portions.

In addition, the measurement member 40 of the present exemplary embodiment may include a body portion 41, a groove portion 42 (i.e., as the receiving portion), and a connection portion 43.

According to the present exemplary embodiment, the body portion 41 of the measurement member 40 may be formed of a flexible circuit board. However, the measurement member 40 is not limited thereto.

In addition, the groove portion 42 formed in the body portion 41 of the measurement member 40 may include a plurality of grooves to which the first protrusion 31b of the first connection member 31, the second protrusion 32b of the second connection member 32, and the third protrusion 33b of the third connection member 33 may be inserted, respectively.

That is, according to the present exemplary embodiment, the first protrusion 31b of the first connection member 31 may be inserted into the first groove 42a, the second protrusion 32b of the second connection member 32 may be inserted into the second groove 42b, and the third protrusion 33b of the third connection member 33 may be inserted into the third groove 42c.

Here, the width of the first protrusion 31b, the width of the second protrusion 31b, and the width of the third protrusion 33b may be wider than the width of each of the first, second, and third grooves 42a, 42b, and 43b to which the first protrusion 31b, the second protrusion 32b, and the third protrusion 33b are respectively inserted.

For example, when the width of the second groove 42b is D1 and the width of the second protrusion 32b is D2, D1 may be smaller than D2. That is, when the second protrusion 32b is inserted into the second groove 42b in the present exemplary embodiment, the second protrusion 32b may be tightly fit into the second groove 42b, and therefore the measurement member 40 may be fixed to the rechargeable module 100 by the second protrusion 32b.

Thus, the measurement member 40 may be fixed to the battery module 100 by inserting protrusions formed in the first to third connection members 31, 32, and 33 into the grooves 42 of the measurement member 40 according to the present exemplary embodiment.

In addition, a circuit (not shown) may be formed in the body portion 41 of the protection circuit board 40 such that the circuit may be connected to the first groove 42a, the second groove 42b, and the third groove 42c of the groove portion 42. Thus, when the first protrusion 31b of the first connection member 31, the second protrusion 32b of the second connection member 32, and the third protrusion 33b of the third connection member 33 are coupled to the grooves 42a, 42b, and 42c formed in the body portion 41 of the measurement body 40, the first connection member 31, the second connection member 32, and the third connection member 33 may be electrically connected with the circuit (not shown) in the measurement member 40.

In addition, one end of the circuit (not shown) formed in the measurement member 40 according to the present exemplary embodiment may extend to the connection portion 43 of the measurement member 40. Thus, as shown in FIG. 1, when the connection portion 43 of the measurement member 40 is electrically connected to a signal draw out portion 21 formed in one end of the receiving container 20, a signal related to a current, a voltage, and/or a temperature of the rechargeable battery 10 may be drawn out to the outside of the battery module 100 through the circuit (not shown) formed in the measurement member 40.

Thus, according to the present exemplary embodiment, voltages, currents, and/or temperatures of the rechargeable batteries forming the battery module 100 may be measured by using only one measurement member 40 without using a plurality of measurement devices. Further, the measurement member 40 may be simply installed in the battery module 100 according to the present exemplary embodiment.

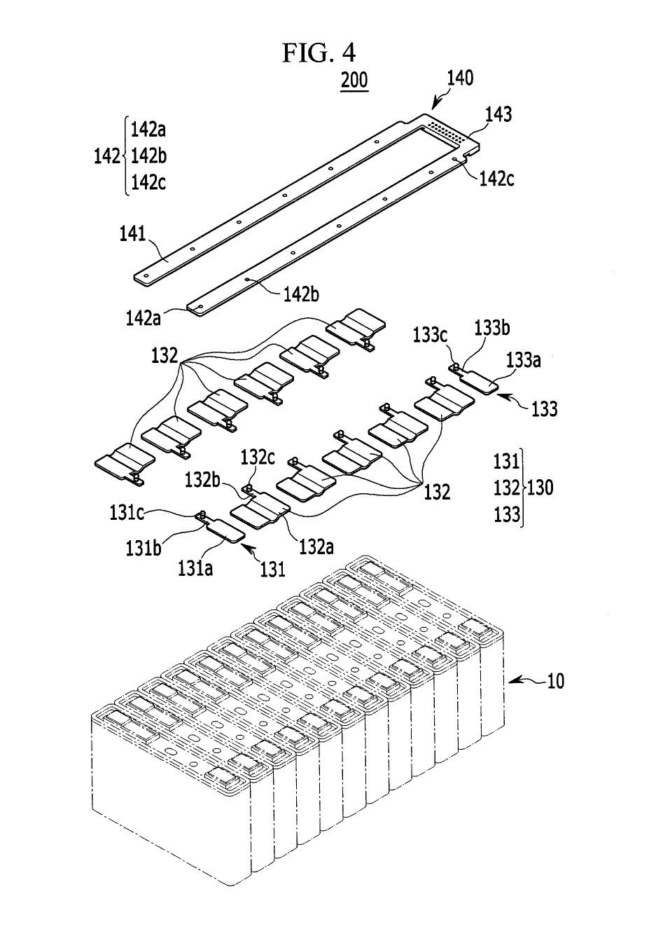

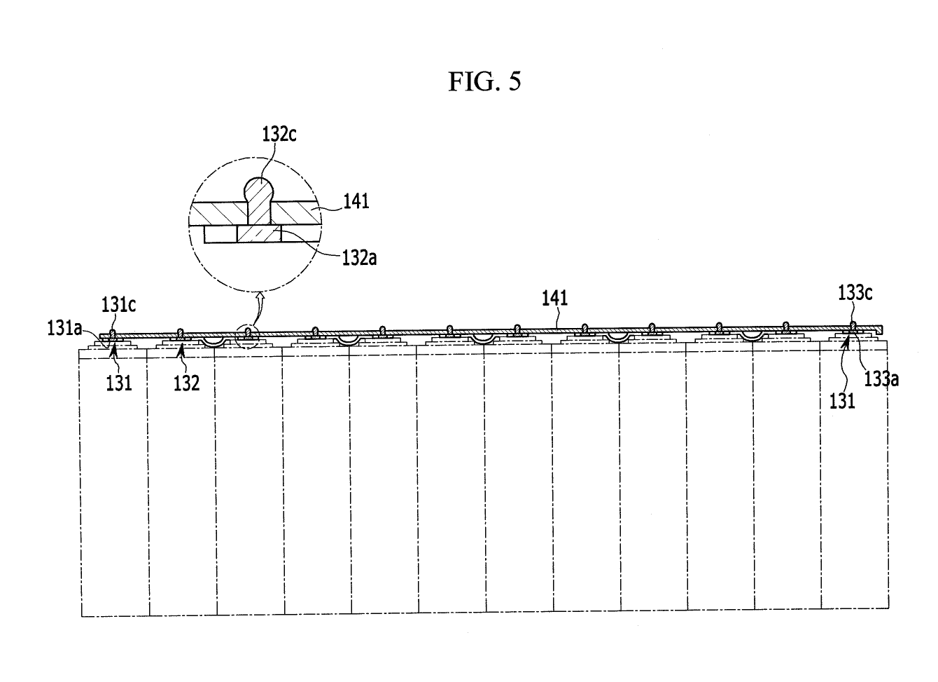

FIG. 4 illustrates a partially exploded perspective view of a connection member and a measurement member according to a second exemplary embodiment, and FIG. 5 illustrates a side view of the connection member and the measurement member of FIG. 4 in a coupled state.

Referring to FIG. 4 and FIG. 5, a battery module 200 according to a second exemplary embodiment may be the same as the battery module 100 of the first exemplary embodiment, except for a connection member 130 and a measurement member 140. Therefore, a description of the same configuration of the battery module 100 of the first exemplary embodiment will not be repeated.

A connection member 130 according to the present exemplary embodiment may include a first connection member 131, a second connection member 132, and a third connection member 133.

The first connection member 131 according to the present exemplary embodiment may include a first body 131 coupled to the second electrode terminal 12 of the outermost rechargeable battery 10 of the battery module 200, a first protrusion extending from one side of the first body 131a, and a first column 131c extending from the first protrusion 131b in a direction that is substantially perpendicular to the extension direction of the first protrusion 131b.

In addition, the second connection member 132 according to the present exemplary embodiment may include a second body 132a coupled to one of the first electrode 11 and the second electrode 12 (e.g., by welding), a second protrusion 132b extending from one side of the second body 132a, and a second column 132b extending from the second protrusion 132b in a direction that is substantially perpendicular to the extension direction of the second protrusion 132b.

Thus, the second body 132a may be partially coupled to the first electrode terminal 11 disposed opposite to the second electrode terminal 12 of the outermost rechargeable battery 10 to which the first connection member 131 is coupled, and the other portion of the second body 132a may be coupled to the second electrode terminal 12 of the neighboring rechargeable battery 10.

Here, the second connection member 132 of the present exemplary embodiment may include a plurality of connection members. Thus, the first electrode terminals 11 and the second electrode terminals 12 formed in the rechargeable batteries 10 coupled in series may be sequentially connected by the plurality of second connection members 132, respectively.

In addition, the third connection member 133 according to the present exemplary embodiment may include a third body 133a, a third protrusion 133b extending from the third body 133a, and a third column 133c extending from the third protrusion 133b in a direction that is substantially perpendicular to the extension direction of the third protrusion 133b.

According to the present exemplary embodiment, the third body 133b of the third connection member 133 may be coupled to the first electrode terminal 11 of the rechargeable battery 10 on the opposite outermost side of the battery module 200 relative to the rechargeable battery 10 to which the first connection member 131 is coupled. Thus, according to the present exemplary embodiment, the rechargeable batteries 10 received in the receiving container 20 may be electrically coupled in series by the first, second, and third connection members 131, 132, and 133.

In addition, the measurement member 140 according to the present exemplary embodiment may include a body portion 141, an opening 142 (i.e., as the receiving portion), and a connection portion 143.

According to the present exemplary embodiment, the body portion 141 of the measurement member 140 may be formed of a flexible circuit board. However, the measurement member 140 is not limited thereto.

The opening 142 formed in the body portion 141 of the measurement member 140 may include a plurality of openings to which a first column 131c of the first connection member 131, a second column 132c of the second connection member 132, and a third column 133c of the third connection member 133 are inserted.

Thus, according to the present exemplary embodiment, the first column 131c of the first connection member 131 may be inserted into the first opening 143, the second column 132c of the second connection member 132 may be inserted into the second opening 142b, and the third column 133c of the third connection member 133 may be inserted into the third opening 142c.

Here, the width of each of the first, second, and third columns 131c, 132c, and 133c according to the present exemplary embodiment may be wider than the width of each of the first, second, and third openings 142a, 142b, and 142c to which the first, second, and third columns 131c, 132c, and 133c are respectively inserted. That is, in the present exemplary embodiment, when the second column 132c is inserted to the second opening 142b, the second column 132c may be tightly fitted to the second opening 142b, and therefore the measurement member 140 may be fixed to the battery module 200 by the second column 132c.

Thus, the measurement member 140 may be fixed to the battery module 200 by inserting the first to third columns 131c, 132c, and 133c formed in the first to third connection members 131, 132, and 133.

Here, as illustrated in FIG. 4, one end of each of the first to third columns 131c, 132c, and 133c according to the present exemplary embodiment may include a portion thicker than the other portion of the columns.

In addition, a circuit (not shown) may be formed in the body portion 141 of the measurement member 140 and the circuit may be connected to the first, second, and third openings 142a, 142b, and 142c. Thus, when the first column 131c of the first connection member 131, the second column 132c of the second connection member 132, and the third column 133c of the third connection member 133 are coupled with the openings 142a, 142b, and 142c formed in the body portion 141 of the measurement member 140, the first connection member 131, the second connection member 132, and the third connection member 133 may be electrically connected with the circuit (not shown) of the measurement member 140.

In addition, one end of the circuit (not shown) formed in the measurement 140 may extend to the connection portion 143 of the measurement member 140. Thus, as illustrated in FIG. 1, when the connection portion 143 of the measurement member 140 is electrically connected to a signal draw out portion 21 formed in one end of the receiving container 20, a signal related to a current, a voltage, and/or a temperature of the rechargeable battery 10 may be drawn out to the outside of the battery module 200 through the circuit (not shown) formed in the measurement member 140.

Thus, according to the present exemplary embodiment, voltages, currents, and/or temperatures of the rechargeable batteries forming the battery module 200 may be measured by using only one measurement member 140 without using a plurality of measurement devices. Further, the measurement member 140 may be simply and stably installed in the battery module 200 according to the present exemplary embodiment.

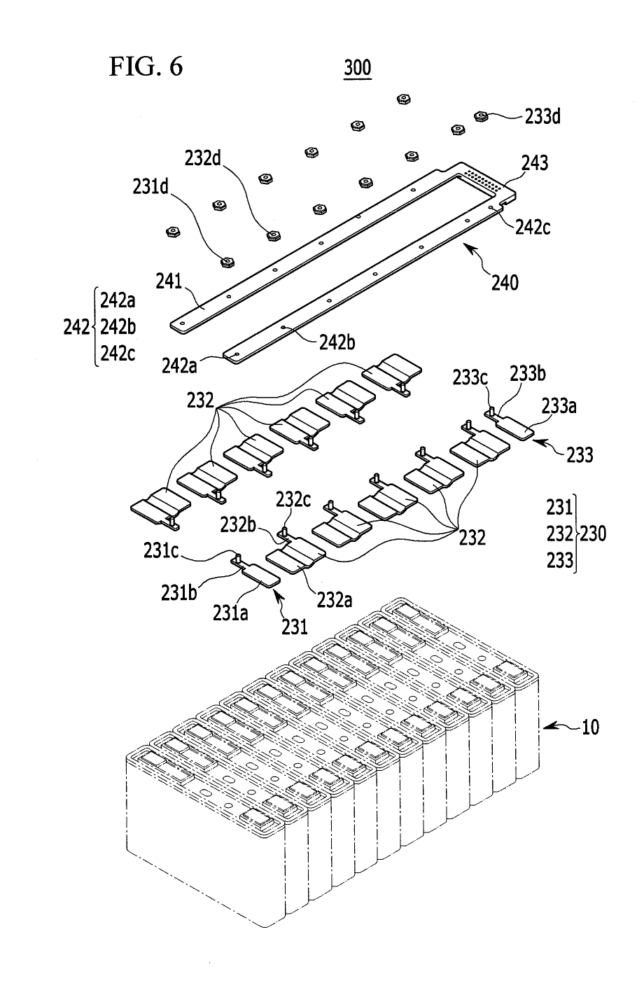

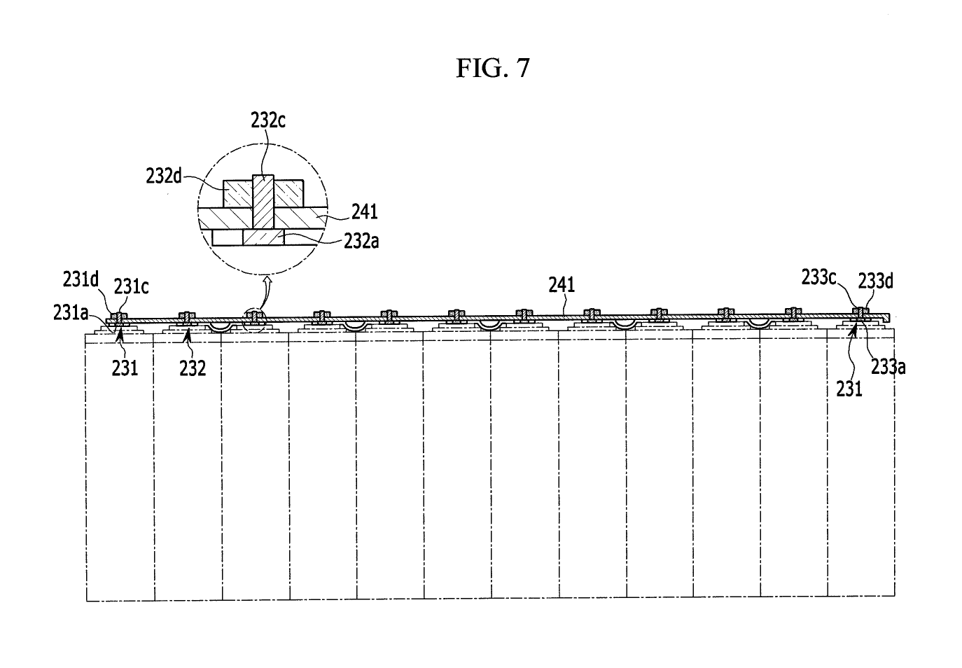

FIG. 6 illustrates a partially exploded perspective view of a connection member and a measurement according to a third exemplary embodiment, and FIG. 7 illustrates a side view of the connection member and the measurement member of FIG. 6 in a coupled state.

Referring to FIG. 6 and FIG. 7, a battery module 300 of the present exemplary embodiment is the same as the battery module 200 of the second exemplary embodiment, except for a connection member 230 and a measurement member 240. Therefore, a description of the same configuration of the battery module 200 of the second exemplary embodiment will not be repeated.

The connection member 230 according to the present exemplary embodiment may include a first connection member 231, a plurality of second connection members 232, and a third connection members 233.

The first connection member 231 of the present exemplary embodiment may include a first body 231a coupled to the second electrode terminal 12 of the outermost rechargeable battery 10 of the battery module 300, a first protrusion 231b extending from one side of the first body 231a, and a first bolt 231c (e.g., as a column) and a first nut 231d (e.g., as a fastener), where the first bolt 231c extends from the first protrusion 231b in a direction that is substantially perpendicular to the extension direction of the first protrusion 231b.

In addition, the second connection member 232 according to the present exemplary embodiment may include a second body 232a coupled to at least one of the first and second electrode terminals 11 and 12 (e.g., by welding), a second protrusion 232b extending from one side of the second body 232a, and a second bolt 232c and a second nut 232d, where the second bolt 232c extends from the second protrusion 232b in a direction that is substantially perpendicular to the extension direction of the second protrusion 232b.

Thus, the second body 232a may be partially coupled to the first electrode terminal 11 disposed opposite to the second electrode terminal 12 of the outermost rechargeable battery 10 to which the first connection member 231 is coupled, and the other portion of the second body 232a may be coupled to the second electrode terminal 12 of the neighboring rechargeable battery 10.

Here, the second connection member 232 of the present exemplary embodiment may include a plurality of connection members. Thus, the first electrode terminals 11 and the second electrode terminals 12 formed in the rechargeable batteries 10 coupled in series may be sequentially connected by the plurality of second connection members 232, respectively.

In addition, the third connection member 233 according to the present exemplary embodiment may include a third body 233a, a third protrusion 233b extending from the third body 233a, and a third bolt 233c and a third nut 233d, where the third bolt 233c extends from the third protrusion 233b in a direction that is substantially perpendicular to the extension direction of the third protrusion 233b.

According to the present exemplary embodiment, the third body 233b of the third connection member 233 may be coupled to the first electrode terminal 11 of the rechargeable battery 10 on the opposite outermost side of the module 300 relative to the rechargeable battery 10 to which the first connection member 231 is coupled. Thus, according to the present exemplary embodiment, the rechargeable batteries 10 received in the receiving container 20 may be electrically coupled in series by the first, second, and third connection members 231, 232, and 233.

In addition, the measurement member 240 according to the present exemplary embodiment may include a body portion 241, an opening 242 (as a receiving portion), and a connection portion 243.

According to the present exemplary embodiment, the body portion 241 of the measurement member 240 may be formed of a flexible circuit board. However, the measurement member 240 is not limited thereto.

The opening 242 formed in the body portion 241 of the measurement member 240 may include a plurality of openings to which the first bolt 131c of the first connection member 231, the second bolt 232c of the second connection member 232, and the third bolt 233c of the third connection member 233 are inserted.

Thus, according to the present exemplary embodiment, the first bolt 231c of the first connection member 231 may be inserted to the first opening 232a, the second bolt 232c of the second connection member 232 may be inserted to the second opening 232b, and the third bolt 233c of the third connection member 233 may be inserted to the third opening 242c.

Subsequently, the first to third nuts 231d, 232d, and 233d according to the present exemplary embodiment may be respectively coupled to the first to third bolts 231c, 232c, and 233c respectively inserted to the first to third openings 242a, 242b, and 242c.

Thus, according to the present exemplary embodiment, the first to third bolts 231c, 232c, and 233c formed in the first to third connection members 231, 232, and 233 are inserted to the openings 142 of the measurement member 240, and the first to third bolts 231c, 232c, and 233c are fixed by the first to third nuts 231d, 232d, and 233d such that the measurement member 240 can be simply fixed to the battery module 300.

In addition, a circuit (not shown) may be formed in the body portion 241 of the measurement member 240 and the circuit may be connected to the first, second, and third openings 242a, 242b, and 242c. Thus, when the first bolt 231c of the first connection member 231, the second bolt 232c of the second connection member 232, and the third bolt 233c of the third connection member 233 are coupled to the openings 242a, 242b, and 242c formed in the body portion 241 of the measurement member 240, the first connection member 231, the second connection member 232, and the third connection member 233 may be electrically connected with the circuit (not shown) of the measurement member 240.

In addition, one end of the circuit (not shown) formed in the measurement member 240 may extend to the connection portion 243 of the measurement member 240. Thus, as shown in FIG. 1, when the connection portion 243 of the measurement member 240 is electrically connected to a signal draw out portion 21 formed in one end of the receiving container 20, a signal related to a current, a voltage, and/or a temperature of the rechargeable battery 10 may be drawn out to the outside of the battery module 300 through the circuit (not shown) formed in the measurement member 240.

Thus, according to the present exemplary embodiment, voltages, currents, and/or temperatures of the rechargeable batteries forming the battery module 300 may be measured by using only one measurement member 240 without using a plurality of measurement devices. Further, the measurement member 240 may be simply and stably installed in the battery module 300 according to the present exemplary embodiment.

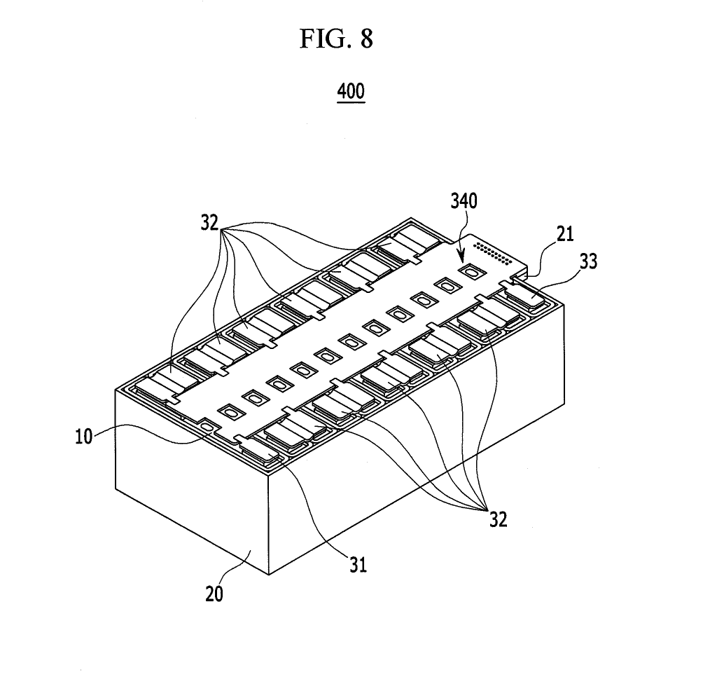

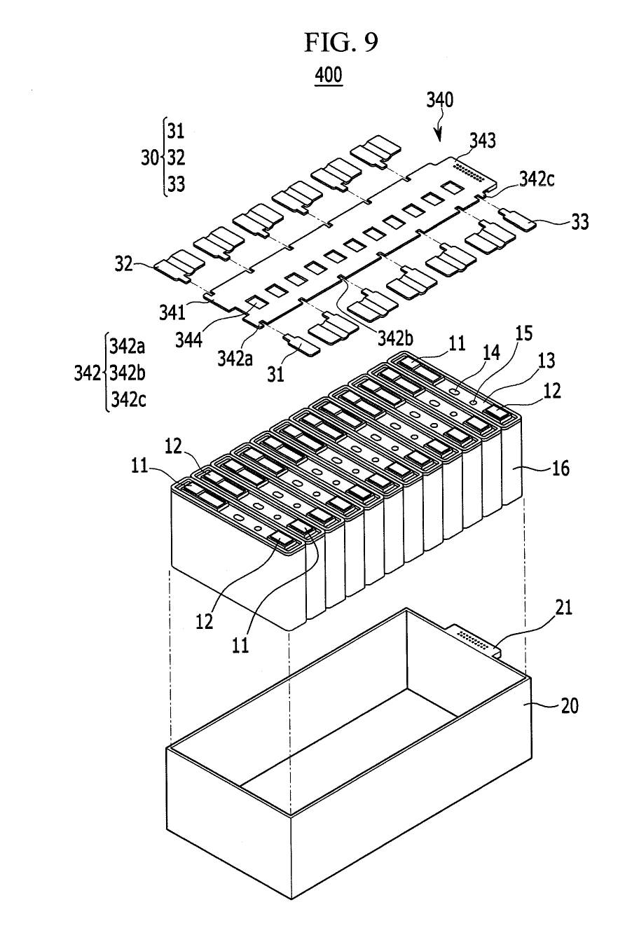

FIG. 8 illustrates a perspective view of a battery module according to a third exemplary embodiment, and FIG. 9 illustrates a partially exploded perspective view of the connection member and the measurement member of FIG. 8.

Referring to FIG. 8 and FIG. 9, a battery module 400 of the present exemplary embodiment is the same as the battery module 100 of the first exemplary embodiment, except for a measurement member 340. Therefore, a description of the same configuration of the battery module 100 of the first exemplary embodiment will not be repeated.

The measurement member 340 according to the present exemplary embodiment may include a body portion 341, a groove 342 (as a receiving portion), an exposure portion 344, and a connection portion 343.

The groove 342 may include a plurality of grooves (i.e., a first groove 342a, second grooves 342b, and a third groove 342c), which may be the same as the first groove 42a, second grooves 42b, and third groove 42c described above relative to FIG. 3. As receiving portions, the grooves 342 may instead be openings (not shown), e.g., the same openings 142 and 242 as described above relative to FIGS. 4 and 6.

The connection portion 343 may be the same as the connection portion 43 described above relative to FIG. 2.

The body portion 341 may include the exposure portion 344. The exposure portion 344 may expose at least one vent hole 14 of the rechargeable batteries 10. The exposure portion 344 may expose all of the vent holes 14 of the rechargeable batteries 10. In FIG. 9, the exposure portion 344 includes a plurality of discrete exposure portions 344 that respectively expose a vent hole 14 of each of the rechargeable batteries 10. However, the exposure portion 344 may also be a single exposure portion that exposes all of the vent holes 14 of the rechargeable batteries 10.

For example, FIGS. 2, 4, and 6 illustrate body portions 41, 141, and 241 with a single exposure portion that exposes all of the vent holes 14 of the rechargeable batteries 10. The single exposure portion in FIGS. 2, 4, and 6 is defined by first and second portions of the body portions 41, 141, and 241 that extend from the connection portions 43, 143, 243 in directions parallel to each other between the electrode terminals 11 and 12 of the rechargeable batteries 10. The single exposure portion in FIGS. 2, 4, and 6 is surrounded on three sides by the measurement members 40, 140, 240. However, the single exposure portion in FIGS. 2, 4, and 6 may be surrounded on four sides, like the exposure portion 344 in FIGS. 8 and 9.

The exposure portion 344 may allow exhaust to efficiently escape from the rechargeable batteries 10 through the vent holes 14 (e.g., in the event of increased internal pressure).

By way of summary and review, a high-power rechargeable battery may use a non-aqueous electrolyte with a high energy density. A battery module may be formed of a plurality of rechargeable battery coupled to each other in series, and the rechargeable battery may have a cylindrical shape or a prismatic shape. Each of the rechargeable batteries forming the battery module may iteratively perform charging and discharging, which may cause performance deterioration in the respective batteries.

In the battery module according to embodiments, the states of the rechargeable batteries forming the battery module may be measured using a simple structure that can be simply installed in the battery module. According to embodiments, voltages, currents, and/or temperatures of the rechargeable batteries forming the battery module may be measured by using only one measurement member without using a plurality of measurement devices.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery module, comprising:
batteries, each of the batteries including electrode terminals;
a measurement member that measures one or more of a voltage, a current, or a temperature of each of the batteries, the measurement member including receiving portions; and
connection members, each of the connection members electrically connecting electrode terminals of neighboring batteries, and each of the connection members including a protrusion extending therefrom, each protrusion being electrically connected to the measurement member and including an uppermost surface that faces away from the batteries, the uppermost surface of each protrusion engaging one of the receiving portions.

2. The battery module as claimed in claim 1, wherein the uppermost surface of each protrusion engages a lower surface of the receiving portion.

3. The battery module as claimed in claim 1, wherein:
the receiving portions are grooves, and
the protrusion of each of the connection members is inserted into one of the grooves.

4. The battery module as claimed in claim 3, wherein:
the grooves each have a first width,
the protrusion of each of the connection members has a second width, and
the first width is smaller than the second width.

5. The battery module as claimed in claim 3, wherein:
the protrusion of each of the connection members extends from an uppermost surface of each of the connection members, and
the uppermost surface of each protrusion is coplanar with the uppermost surface of each of the connection members.

6. The battery module as claimed in claim 1, further comprising a column on the protrusion of each of the connection members, wherein:
the receiving portions are through-holes, and
the column of each of the connection members projects through one of the through-holes.

7. The battery module as claimed in claim 6, wherein:
the protrusion of each of the connection members extends from an uppermost surface of each of the connection members in a direction parallel to the uppermost surface of each of the connection members, and
the column of each of the connection members projects from the protrusion in a direction perpendicular to the uppermost surface of each of the connection members.

8. The battery module as claimed in claim 6, wherein:
the column of each of the connection members has a first portion with a first diameter and a second portion with a second diameter,
the second portion is between the first portion and the protrusion of each of the connection members, and
the first diameter is greater than the second diameter.

9. The battery module as claimed in claim 6, wherein the column of each of the connection members is coupled to the measurement member with a separate fastener.

10. The battery module as claimed in claim 1, wherein each of the connection members is welded to a first electrode terminal of one battery and a second electrode terminal of a neighboring battery.

11. The battery module as claimed in claim 1, wherein:
the electrode terminals of the batteries are arranged in a first row and a second row,
the first row is substantially parallel to the second row, and
the connection members include:
first connection members over the electrode terminals arranged in the first row, and
second connection members over the electrode terminals arranged in the second row.

12. The battery module as claimed in claim 1, further comprising single-terminal connection members, each of the single-terminal connection members being electrically connected to one of the electrode terminals of only one of the batteries, wherein:
each of the single-terminal connection members includes a protrusion that extends therefrom,
each protrusion of the single-terminal connection members is electrically connected to the measurement member, and includes an uppermost surface that faces away from the batteries, and
the uppermost surface of each protrusion of the single-terminal connection members engages one of the receiving portions.

13. The battery module as claimed in claim 12, wherein:
the batteries are arranged in a stack,
the stack includes a first battery on a first side of the stack and a second battery on a second side of the stack,
the first side is opposite the second side, and
the single-terminal connection members include:
a first single-terminal connection member electrically connected to one of the electrode terminals of only the first battery, and
a second single-terminal connection member electrically connected to one of the electrode terminals of only the second battery.

14. The battery module as claimed in claim 1, wherein the measurement member includes a flexible circuit board.

15. A battery module, comprising:
batteries, each of the batteries including electrode terminals and a vent hole;
a measurement member that measures one or more of a voltage, a current, or a temperature of each of the batteries, the measurement member including at least one exposure portion and receiving portions, the at least one exposure portion exposing at least one vent hole of the batteries; and
connection members, each of the connection members electrically connecting electrode terminals of neighboring batteries and including a protrusion, the protrusion of each of the connection members being electrically connected to the measurement member and engaging one of the receiving portions.

16. The battery module as claimed in claim 15, wherein:
the measurement member includes a first body portion and a second body portion,
the first body portion and the second body portion extend along opposite sides of the at least one exposure portion, and
the first body portion and the second body portion extend between the electrode terminals of each of the batteries.

17. The battery module as claimed in claim 15, wherein the at least one exposure portion exposes the vent hole of each of the batteries.

18. The battery module as claimed in claim 17, wherein:
the at least one exposure portion includes a first exposure portion and a second exposure portion,
the first exposure portion exposes a first vent hole of a first battery, and
the second exposure portion exposes a second vent hole of a second battery.

19. The battery module as claimed in claim 17, wherein the at least one exposure portion is a single exposure portion that exposes all of the vent holes of the batteries.
